(19) United States
(12) Patent Application Publication
(10) Pub. No.: US 2017/0207425 A1
(43) Pub. Date: Jul. 20, 2017

(54) METHOD OF USING A CABLE TYPE BATTERY

(71) Applicant: LG ELECTRONICS INC., Seoul (KR)

(72) Inventors: Sinae CHUN, Seoul (KR); Jihwan KIM, Seoul (KR); Sihwa PARK, Seoul (KR); Doyoung LEE, Seoul (KR)

(73) Assignee: LG ELECTRONICS INC., Seoul (KR)

(21) Appl. No.: 15/324,611

(22) PCT Filed: Aug. 25, 2014
(86) PCT No.: PCT/KR2014/007872

§ 371 Date: Jan. 6, 2017

(30) Foreign Application Priority Data
Jul. 8, 2014 (KR) 10-2014-0085496

(51) Int. Cl. H01M 2/02; A45C 13/00; A45C 3/04; H01M 10/42

(52) U.S. Cl. CPC H01M 2/0202; H01M 10/425; A45C 13/001; A45C 3/04; H01M 2002/0205; H01M 2220/30

(57) ABSTRACT

A method of using a cable type battery in a product including a cable type battery, a display, and a memory includes: starting power supply from the cable type battery in response to a trigger signal occurring when satisfying a predetermined condition; driving a driving application stored at the memory; and outputting image data stored at the memory through the display.

### TECHNICAL FIELD

The present invention relates to a method of using a cable type battery.

### BACKGROUND ART

Nowadays, due to the development of technology related to various portable devices, a demand for a rechargeable battery more increases. Rechargeable batteries are generally a cylindrical battery, a square-shaped battery, or a pouch type battery. This is because a rechargeable battery is produced by mounting an electrode assembly formed with a negative electrode, a positive electrode, and a separation membrane within a cylindrical or square-shaped metal can or a pouch type case of an aluminum laminate sheet and by injecting an electrolyte into the electrode assembly. Therefore, because a constant space for mounting a rechargeable battery is essentially required, there is a problem that a cylindrical form, a square-shaped form, or a pouch type form of such a rechargeable battery operates as a restriction in developing various forms of portable devices. Accordingly, the development of a new form of rechargeable battery that can easily change a form is requested and the new form of rechargeable battery may be applied to various electronic devices with various methods.

### DISCLOSURE OF INVENTION

### Technical Problem

The present invention has been made in an effort to provide various methods of using a cable type battery that can easily change a form as a power supply source for performing a function that can use in various household items as well as various forms of portable electronic devices and a fixed type electronic device.

### Solution to Problem

An exemplary embodiment of the present invention provides a method of using a cable type battery in a product including a cable type battery, a display, and a memory including: starting power supply from the cable type battery in response to a trigger signal occurring when satisfying a predetermined condition; driving a driving application (i.e., application program) stored at the memory; and outputting image data stored at the memory through the display.

The product may be a shopping bag. The cable type battery may be housed in a handle of the shopping bag or may be housed in a packing material forming a body of the shopping bag. The outputting of image data stored at the memory may include: detecting a product received in the shopping bag; and calling different image data from the memory based on the detected product and outputting the image data through the display. The trigger signal may occur when a user holds the handle and may occur when a predetermined product is received within the shopping bag.

The product may be a packing box. The cable type battery may be housed in a packing means of the packing box and may be housed in a packing material forming a body of the packing box. The trigger signal may occur when packing of the packing box is released by the packing means. The outputting of image data stored at the memory may include: detecting a product received in the packing box; and calling different image data from the memory based on the detected product and outputting the image data through the display.

Another exemplary embodiment of the present invention provides a method of using a cable type battery in a product including a cable type battery, a memory, and an output unit including: detecting a predetermined user operation for the product or a predetermined state change of the product; starting power supply from the cable type battery by connecting an electrode of the cable type battery and an electrode of the product based on the detect result; and controlling the output unit to perform a specific function corresponding to the predetermined user operation or the predetermined state change of the product by driving an application program stored at the memory based on power supplied from the cable type battery.

The specific function may include at least one of: a function of outputting image data stored at the memory through a display unit included in the output unit; and a function of outputting audio data stored at the memory through an audio output unit included in the output unit.

The cable type battery may be implemented in a string form. The predetermined user operation may include at least one of operation of winding the cable type battery in the product, operation of unwinding the cable type battery wound in the product, operation of tying a knot with the cable type battery, and operation of untying the knot tied with the cable type battery.

The product may be a shopping bag. The predetermined user operation may include operation in which the user holds a handle of the shopping bag. The predetermined state change of the product may be a state change in which a product is received in the empty shopping bag.

The product may include a watch type electronic device having a band including the cable type battery, and the state change of the product may include a contact of one end and the other end of the band in a state in which power of the electronic device is turned off.

When the produce is a watch type electronic device, the specific function may include a function of turning on the electronic device by power supplied by the cable type battery.

The electronic device may be charged by the cable type battery after one end and the other end of the band contact, and when the contact is released, the electronic device may control to stop the charge.

The electronic device may turn off the display unit after a charge state by the cable type battery is displayed in a display unit of the electronic device, when the contact is released.

The product may include the cable type battery and include a watch type electronic device having a band having elasticity, and the state change of the product may include a change of elasticity of the band or a change of an external form of the band in a state in which the band is worn in a user arm.

The specific function may include a function of executing an event received from the outside based on a state change of the product.

The specific function may include a function of terminating a previously executing application.

The specific function may include a function of converting a mode of the watch type electronic device to an exercise mode, when a diameter of the band increases due to a change of elasticity of the band in a state in which the band is worn in an arm of the user.

### Advantageous Effects of Invention

According to the present invention, power of a cable type battery in new, funny, and various forms of products can be used as a driving power source.

### BRIEF DESCRIPTION OF DRAWINGS

FIG. 1 is a block diagram illustrating a configuration of a product that houses a cable type battery;

FIG. 2 is a cross-sectional view illustrating a cable type battery according to an exemplary embodiment of the present invention;

FIG. 3 is a flowchart illustrating an example of a method of using a cable type battery according to an exemplary embodiment of the present invention;

FIG. 4 is a diagram illustrating an example of using a cable type battery as a battery of a flexible display according to an exemplary embodiment of the present invention;

FIG. 5 is a diagram illustrating an example of accessories that can perform a specific function using a housed cable type battery according to an exemplary embodiment of the present invention;

FIG. 6 is a diagram illustrating an example of including and using a cable type battery in a packing string according to an exemplary embodiment of the present invention;

FIG. 7 is a flowchart illustrating another example of a method of using a cable type battery according to an exemplary embodiment of the present invention;

FIG. 8 is a diagram illustrating a power supply cable including a cable type battery according to an exemplary embodiment of the present invention;

FIG. 9 is a diagram illustrating clothing including a string that houses a cable type battery according to an exemplary embodiment of the present invention;

FIG. 10 is a perspective view illustrating an example of using a cable type battery housed in a string in a diary having a display function according to an exemplary embodiment of the present invention;

FIG. 11 is a diagram illustrating an example of charging a smart watch using a cable type battery included in an end portion of a sleeve of clothing according to an exemplary embodiment of the present invention;

FIG. 12 is a diagram illustrating an example of using a cable type battery as a power supply source of a security string that can perform a specific function according to an exemplary embodiment of the present invention;

FIG. 13 is a diagram illustrating an example of an identification card including a cable type battery according to an exemplary embodiment of the present invention;

FIG. 14 is a diagram illustrating functional clothing including a cable type battery that can be charged by external supply power according to an exemplary embodiment of the present invention;

FIG. 15 is a diagram illustrating a jump rope that houses a cable type battery to perform a predetermined function according to an exemplary embodiment of the present invention;

FIG. 16 is a diagram illustrating a fishing rod including a cable type battery according to an exemplary embodiment of the present invention;

FIG. 17 is a diagram illustrating an example of using a cable type battery housed in a string 590 as an auxiliary battery of a camera according to an exemplary embodiment of the present invention;

FIG. 18 is a diagram illustrating an example of a pet lead including a cable type battery according to an exemplary embodiment of the present invention;

FIG. 19 is a diagram illustrating a key ring that houses a cable type battery according to an exemplary embodiment of the present invention;

FIG. 20 is a diagram illustrating an example of an electronic note including a ring fixing means that houses a cable type battery according to an exemplary embodiment of the present invention;

FIG. 21 is a diagram illustrating an example of a shopping bag including a handle including a cable type battery according to an exemplary embodiment of the present invention;

FIG. 22 is a flowchart illustrating another example of a method of using a cable type battery according to an exemplary embodiment of the present invention;

FIG. 23 is a diagram illustrating an example of an ornament means of a cable form including a cable type battery according to an exemplary embodiment of the present invention;

FIG. 24 is a diagram illustrating an example of a blind system driving with a cable type battery according to an exemplary embodiment of the present invention;

FIG. 25 is a diagram illustrating an example of a tent including a cable type battery that can be used as a power supply source of a related electronic device according to an exemplary embodiment of the present invention;

FIG. 26 is a diagram illustrating a tennis racket including a racket line including a cable type battery according to an exemplary embodiment of the present invention;

FIG. 27 is a cross-sectional view illustrating a screw including a cable type battery according to an exemplary embodiment of the present invention;

FIG. 28 is a diagram illustrating an example of using a string of a material that houses a cable type battery therein as a kite line according to an exemplary embodiment of the present invention;

FIG. 29 is a diagram illustrating a button fixed by a thread that houses a cable type battery according to an exemplary embodiment of the present invention;

FIG. 30 is a diagram illustrating an example of a phone number board that houses a cable type battery according to an exemplary embodiment of the present invention;

FIG. 31 is a diagram illustrating an example of a handicraft made using a wire that houses a cable type battery according to an exemplary embodiment of the present invention;

FIG. 32 is a diagram illustrating an example of using a material of a cable type battery as a filament material of a 3D printer according to an exemplary embodiment of the present invention;

FIG. 33 is a diagram illustrating an example of a lunch box that houses a cable type battery according to an exemplary embodiment of the present invention;

FIG. 34 is a diagram illustrating an example of a tape that houses a cable type battery according to an exemplary embodiment of the present invention;

FIG. 35 is a diagram illustrating an example of a clothing string that houses a cable type battery according to an exemplary embodiment of the present invention;

FIG. 36 is a diagram illustrating an example of a tag that houses a cable type battery according to an exemplary embodiment of the present invention;

FIG. 37 is a diagram illustrating an example of a divide string of a book that houses a cable type battery according to an exemplary embodiment of the present invention;

FIG. 38 is a diagram illustrating an example of a safety belt that houses a cable type battery according to an exemplary embodiment of the present invention;

FIG. 39 is a diagram illustrating an example of an umbrella that houses a cable type battery according to an exemplary embodiment of the present invention;

FIG. 40 is a diagram illustrating a method of using a cable type battery according to an exemplary embodiment of the present invention;

FIG. 41 is a flowchart illustrating another example of a method of using a cable type battery according to an exemplary embodiment of the present invention;

FIG. 42 is a flowchart illustrating another example of a method of using a cable type battery according to an exemplary embodiment of the present invention;

FIGS. 43 to 45 are diagrams illustrating an example of a watch type electronic device that houses a cable type battery according to an exemplary embodiment of the present invention; and

FIGS. 46 to 48 are diagrams illustrating an example of controlling operation of a watch type electronic device with a change of an external form of a cable type battery.

### MODE FOR THE INVENTION

Hereinafter, exemplary embodiments of the present invention will be described in detail with reference to the attached drawings, like reference numerals designate like elements throughout the specification, and the drawings and description are to be regarded as illustrative in nature and not restrictive. In general, a suffix such as “module” and “unit” may be used to refer to elements or components. Use of such a suffix herein is merely intended to facilitate description of the specification, and the suffix itself is not intended to give any special meaning or function. Further, detailed descriptions of well-known functions and structures incorporated herein may be omitted to avoid obscuring the subject matter of the present invention. The accompanying drawings are used to help easily understand various technical features and it should be understood that the embodiments presented herein are not limited by the accompanying drawings. While the present invention may be embodied in many different forms, specific embodiments of the present invention are shown in drawings and are described herein in detail, with the understanding that the present invention is to be considered as an exemplification of the principles of the invention and is not intended to limit the invention to the specific embodiments illustrated.

A term of a first and a second may be used for describing various elements, but such elements are not limited by such terms. Such terms are used for distinguishing one element from another element.

Throughout this specification and the claims that follow, when it is described that an element is “coupled” to another element, the element may be “directly coupled” to the other element or “electrically coupled” to the other element through a third element. In contrast, when an element is “directly coupled” to another element, there are no intervening elements present.

Singular forms used here include a plurality of forms unless phrases explicitly represent an opposite meaning.

Further, in the present disclosure, a term “comprise” or “have” indicates presence of a characteristic, numeral, step, operation, element, component, or combination thereof described in a specification and does not exclude presence or addition of at least one other characteristic, numeral, step, operation, element, component, or combination thereof.

FIG. 1 is a block diagram illustrating a configuration of a product 10 that houses a cable type battery.

Such a product may be various electronic devices using a cable type battery 100 as a power supply source and may be an equipment or clothing that can perform a specific function using power of the cable type battery 100. However, a range of the present invention is not limited thereto.

Referring to FIG. 1, the product 10 includes a communication unit 20, an input unit 30, a sensing unit 40, an output unit 50, a memory 60, an interface unit 70, a controller 80, and a power supply unit 90. Constituent elements of FIG. 1 are not an essential element constituting the product 10, and thus a product described in the present specification may have constituent elements more than or fewer than that of the foregoing constituent elements.

The communication unit 20 can enable the product 10 to perform a communication function with an external device. The communication function may include a long distance communication function with a mobile communication network and a broadcasting communication network and a short range wireless communication function with a WiFi network or a Zigbee communication network and may include a communication function through various wire networks. However, a range of the present invention is not limited thereto.

The input unit 30 may include at least one means for inputting information to the product 10. The at least one means may include various input means such as a camera, a keyboard, a microphone, a touch screen, and a mouse. However, a range of the present invention is not limited thereto.

The sensing unit 40 may include at least one sensing means for detecting various data necessary for operation of the product 10. The sensing means may include an acceleration sensor, a gravity sensor, a temperature sensor, an audio sensor, a fingerprint detection sensor, a light sensor, a motion sensor, and a pressure sensor. However, a range of the present invention is not limited thereto.

The sensing unit 40 may detect a specific operation of a user for the product 10. The sensing unit 40 may detect a state change of the product 10. A detection result of such a sensing unit 40 may become a base to perform a specific function corresponding to a state change or a specific operation of the user in the product 10.

The output unit 50 is a constituent element that generates an output related to visual sense, auditory sense, or tactile sense and may include a display unit 51 and an audio output unit 52, as shown in FIG. 1. Although not shown in FIG. 1, the output unit 50 may further include a haptic module or a light output unit. However, subordinate constituent elements that may be included in the output unit 50 are not limited to the above-described elements.

The memory 60 may store a driving application (i.e., application program) necessary for operating the product 10 and store various image data or audio data. In the memory 60, data acquired while operating the product may be temporarily or permanently stored. The memory 60 may include a volatile memory or a nonvolatile memory.

The interface unit 70 performs a passage function of connecting the product 10 to various kinds of external devices. Such an interface unit 70 may perform a communication port function, a charge port function, a memory card port function, and an identification module port function with the external device. However, a function of the interface unit 70 is not limited to the above-described examples.

The controller 80 controls general operations of the product 10 in addition to operation related to various application programs. The controller 80 processes a signal, data, and information input or output through the foregoing constituent elements or drives an application program stored at the memory 60, thereby providing appropriate information or function to a user or processing the information or function.

Further, in order to drive an application program stored at the memory 60, the controller 80 may control at least a portion of constituent elements described with reference to FIG. 1. Further, for driving of various application programs, the controller 80 may combine and operate at least two of constituent elements included in the product 10.

The power supply unit 90 receives external power and internal power under the control of the controller 80 to supply power to each constituent element included in the product 10. Such a power supply unit 90 may include the cable type battery 100. The cable type battery 100 may be charged based on external power.

When a predetermined state change or a predetermined user operation for the product 10 is detected, the controller 80 may start power supply by the cable type battery 100. Although not described in detail in the drawing, power supply by the cable type battery 100 may be performed by a connection between an electrode of the cable type battery 100 and an electrode provided in the controller 80.

A connection between the electrodes may be a mechanical connection of a physical switch by a physical force occurring based on a state change or a predetermined operation of the user and may be performed by a switching operation of a micro switching element in which a transistor includes a diode based on a control signal occurring based on a state change or a predetermined operation of the user.

In the present specification, power supply from the cable type battery 100 to the product 10 may be performed by the above-described electrode connection. A power supply operation from the cable type battery 100 by a connection between an electrode of the cable type battery 100 and an electrode of the product 10 will become apparent to a person of ordinary skill in the art, and thus in the following exemplary embodiments, a detailed description thereof will be omitted.

Hereinafter, various cable type battery use forms in a product including the cable type battery 100 will be described. First, a cable type battery will be described.

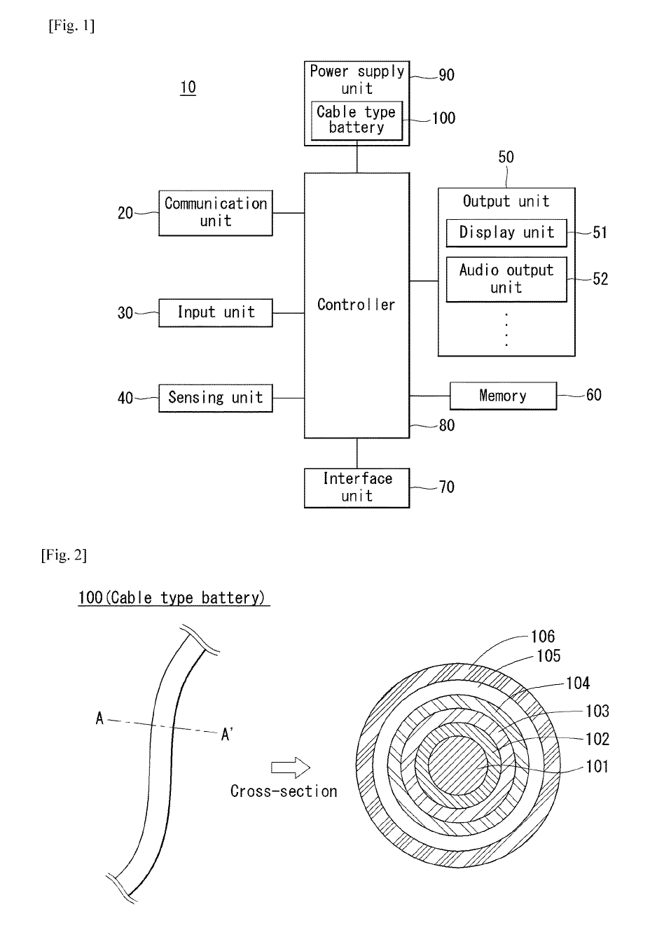

FIG. 2 is a cross-sectional view illustrating a cable type battery 100 according to an exemplary embodiment of the present invention.

A cable type battery 100 applied to an implementation of an exemplary embodiment of the present invention is described in detail in Korean Patent Laid-Open Publication No. 10-2012-0019977, and a cross-section of the cable type battery 100 will simply be described.

The cable type battery 100 is a rechargeable battery and may include a negative electrode current collector 101 that has a predetermined shape of horizontal cross-section and extended in a lengthwise direction, a negative electrode active material pattern layer 102 that has negative electrode active material patterns separately formed at a predetermined gap at an outer surface of the negative electrode current collector, an electrolyte layer 103 that encloses a negative electrode active material pattern layer and that becomes a passage of filled ions, a positive electrode active material pattern layer 104 that has positive electrode active material patterns separately formed at a predetermined gap at a location corresponding to the negative electrode active material patterns at an outer surface of the electrolyte layer, and a positive electrode current collector 105 that encloses an outer surface of a positive electrode active material pattern layer. Here, a predetermined shape means that a shape is not particularly limited and may be any shape that does not depart from the spirit or scope of the present invention. A cable type battery according to the present invention has a predetermined shape of horizontal cross-section, and has a linear structure long extended in a lengthwise direction of a horizontal cross-section, and can be freely changed due to flexibility.

A cable type battery 210 may have a protection sheath 216. The protection sheath 216 is an insulator and is formed at an outer surface of the positive electrode current collector 105 in order to protect an electrode from moisture of the air and an external impact. As the protection sheath 106, a normal polymer resin may be used, for example, a Poly Vinyl Chloride (PVC), High-Density Polyethylene (HDPE), or epoxy resin may be used.

In the foregoing description, a cross-section structure of the cable type battery 100 has been simply described, but the present invention is not limited thereto. For example, in order to compensate various problems that may occur by added flexibility due to a configuration of a cable type battery, an appropriate structural design change may be performed.

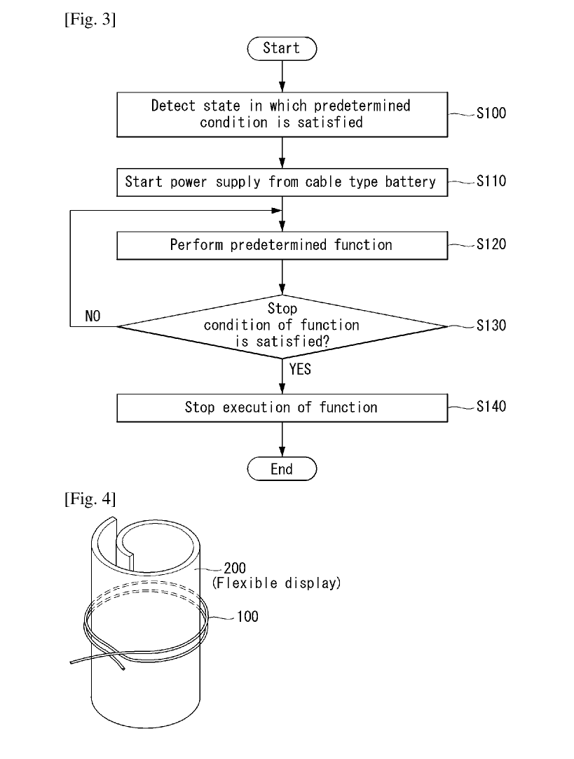

FIG. 3 is a flowchart illustrating an example of a method of using a cable type battery according to an exemplary embodiment of the present invention. Hereinafter, a method of using the cable type battery will be described with reference to necessary drawings.

A controller of a product that houses a cable type battery detects a state in which a predetermined condition is satisfied (S100). Thereafter, the controller starts power supply from the cable type battery housed in the product based on a trigger signal occurring when a predetermined condition is satisfied (S110).

The controller drives a driving application (i.e., application program) stored at a memory based on power supply from the cable type battery and performs a predetermined function (S120). Here, a predetermined function may include an output of image data or audio data stored at the memory, a light output, providing of driving power to constituent elements of a simple product, and acquisition and providing of location information of the product. However, a range of the present invention is not limited thereto.

Thereafter, the controller determines whether a stop condition of an executing function is satisfied (S130). If a stop condition of an executing function is satisfied, the controller stops execution of a function (S140), and if a stop condition of an executing function is not satisfied, the controller continues to execute a function. Here, satisfying of a stop condition may include residual quantity shortage of the cable type battery and stop by a user.

FIG. 4 is a diagram illustrating an example of using a cable type battery 100 as a battery of a flexible display 200 according to an exemplary embodiment of the present invention. Although not described in the drawing, the cable type battery 100 is electrically connected to the flexible display 200.

The cable type battery 100 may be used as a means (i.e., string) for constantly maintaining a form of the flexible display 200. In this case, the cable type battery 100 may be used as a driving power supply source of the flexible display 200. The flexible display 200 may activate only a portion contacting with the cable type battery 100 as a display area. Because a portion that does not contact with the cable type battery 100 of the flexible display 200 is not shown to a user, power supply to the portion is intercepted. Power efficiency of the flexible display 200 may be increased based on such operation. The flexible display 200 may determine whether the cable type battery 100 contacts based on a pressure or an electromagnetic force discharged from the cable type battery 100.

The flexible display 200 may grasp a twist level of the cable type battery 100 to control on/off thereof. For example, if the number wound by the cable type battery 100 is equal to or greater than the predetermined number, the flexible display 200 may be turned on, and if the number wound by the cable type battery 100 is less than the pre-determined number, the flexible display 200 may be turned off.

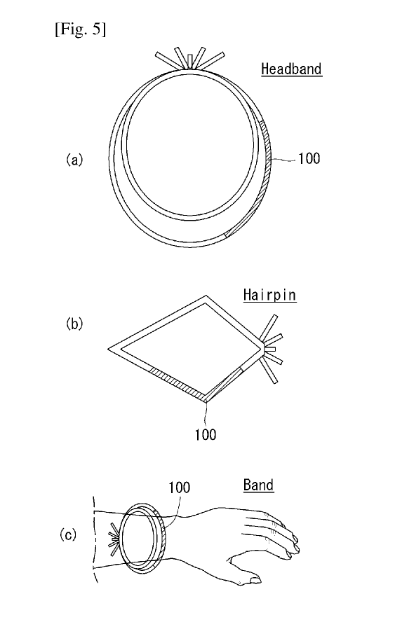

FIG. 5 is a diagram illustrating an example of accessories that can perform a specific function using a housed cable type battery 100 according to an exemplary embodiment of the present invention. The specific function may be a location measuring function, a user body information acquiring function, an alarm function, a display function, and an audio output function. However, a range of the present invention is not limited thereto.

FIG. 5A illustrates an example of using the cable type battery 100 as a battery for supplying power to a headband having an alarm function. A portion of the headband includes the cable type battery 100, but an entire headband may have a form that encloses the cable type battery 100 according to an implementation. This is the same as an example shown in FIGS. 5B and 5C.

An alarm function may be set based on a wearing form of the headband, the number that winds the headband in a user head, an extended level of the headband having elasticity, and a form in which the headband contacts with a user head.

FIG. 5B illustrates an example of using the cable type battery as a power supply source of a headband that can provide a location track function using a Global Positioning System (GPS).

FIG. 5C illustrates an example of using the cable type battery 100 as a power supply source of a band in which a body information acquisition function of a user is mounted. Body information of the user may be a body temperature, a heart rate, and a blood pressure. However, a range of the present invention is not limited thereto. User body information acquired by the band may be changed by a form in which the band is wound in a user wrist, an extended level of the band having flexibility, and a form in which the band contacts with a user wrist.

As described above, accessories formed in a string form may provide an intuitive user interface function of a function mounted in accessories based on flexibility of a string, winding or twist of a string, and a form of a string.

FIG. 6 is a diagram illustrating an example of including and using a cable type battery 100 in a packing string 210 according to an exemplary embodiment of the present invention.

FIG. 6A illustrates that a box 220 is packed using the packing string 210 including the cable type battery 100. FIG. 6B illustrates that a controller (not shown) included in the box 220 controls to display an image message stored at a memory (not shown) using power of the cable type battery 100 in a display 230 and to output an audio signal corresponding to the image message through a speaker 240 when a user unties the packing string 210. That is, when the string 210 is tied, power supply of the cable type battery 100 is intercepted, but a moment in which the string 210 is untied, power supply of the cable type battery 100 is started.

The image message may be an advertisement image for advertisement of a product. The image message may be an image in which a person that gives a gift directly records in order to transfer the gift to a person that receives the gift. Such an image message may be acquired by a camera (not shown) or a microphone (not shown) provided in the box 220 and may be received from an external device through a wire/wireless interface path.

The controller may control a reproduction level of the image message in consideration of a level in which the string 210 is untied. For example, when the string 210 is untied by a half, the controller may reproduce a portion of the image message, and when the string 210 is entirely untied, the controller may reproduce the remaining portion of the image message. According to another implementation of the present invention, the controller may control a reproduction speed or a reproduction level of the image message in consideration of a speed in which the string 210 is untied.

FIG. 6 illustrates an example of outputting an image message in the box 220, and the box 220 may output only a voice message stored at a memory through the speaker 240. That is, the box may include only a speaker instead of a display according to a kind thereof.

When the cable type battery 100 is formed in a string form, a user operation for outputting an image message or a voice message may include operation of winding the cable type battery 100 in a product, operation of tying a knot with the cable type battery 100, and operation of untying a knot by the cable type battery 100 according to another implementation of the present invention.

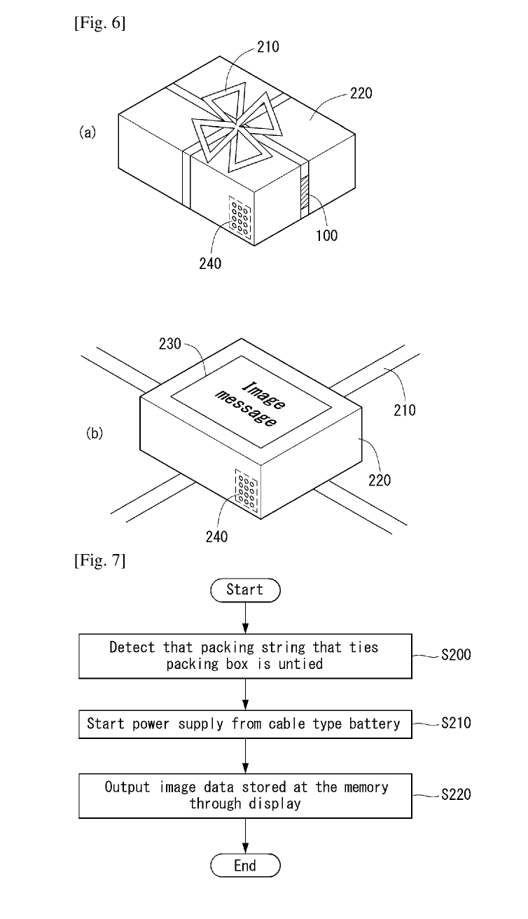

FIG. 7 is a flowchart illustrating another example of a method of using a cable type battery according to an exemplary embodiment of the present invention. Hereinafter, a method of using the cable type battery will be described with reference to necessary drawings. For reference, a method of using the cable type battery is a method of using in an exemplary embodiment described with reference to FIG. 6.

In a state in which a packing box 220 is sealed by a packing string 210 that houses a cable type battery, it is detected that the string 210 is untied (S200). Thereafter, a controller (not shown) provided within the packing box 220 starts power supply from the cable type battery in response to a trigger signal occurring by untying of the string 210 (S210). In this case, the packing box 220 may further include a sensing means (not shown) for detecting that the string 210 is untied.

The controller drives a driving application (i.e., application program) stored at a memory (not shown) based on power supply from the cable type battery and controls a display 230 to output image data stored at the memory (S220). Image data output through the display 230 may be changed according to a product received in the packing box 220. That is, the controller calls different image data from the memory according to a kind of the received product and controls the display 230 to output the image data.

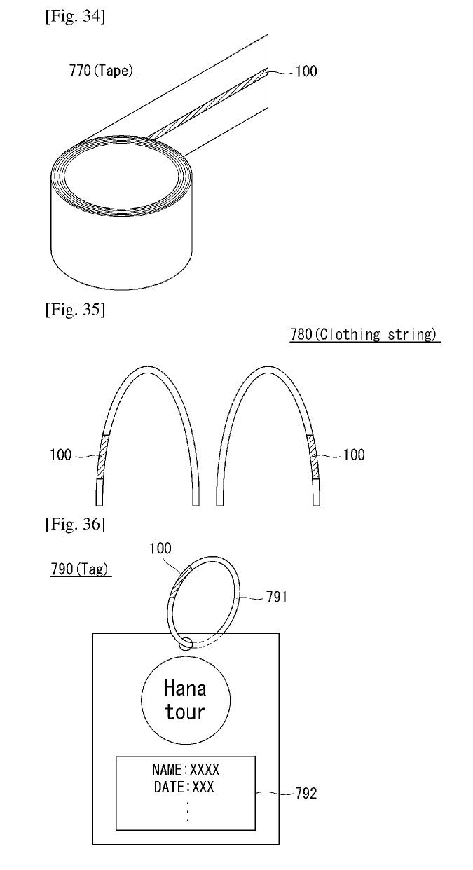

Unlike the present exemplary embodiment, a cable type battery, which is a power supply source for outputting image data may be housed in a packing material constituting a body of the packing box. A means of sealing the packing box may be a packing tape instead of a packing string. In this case, as in an exemplary embodiment of FIG. 34, the cable type battery may be housed in a packing tape. A trigger signal to be a starting point of an image data output through the box may occur when releasing packing of the packing box by removing the packing tape.

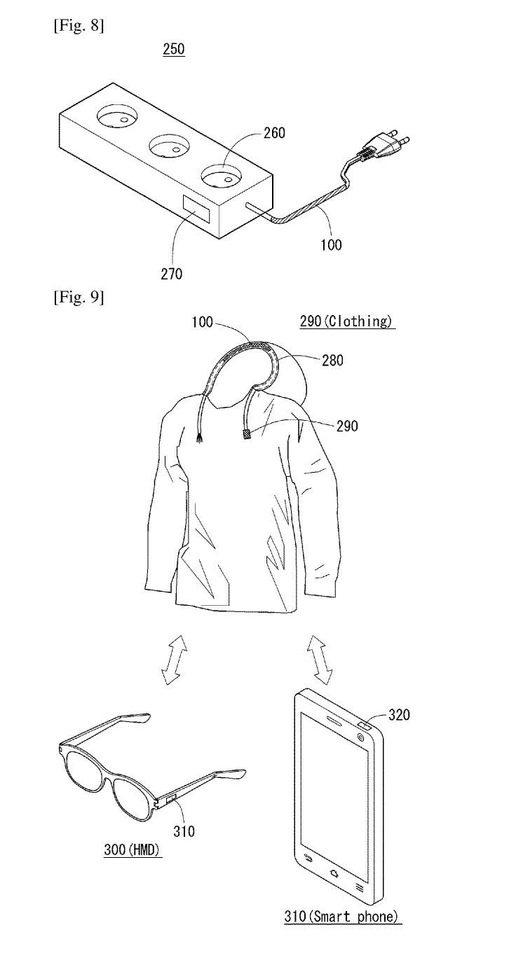

FIG. 8 is a perspective view illustrating a power supply cable 250 including a cable type battery 100 according to an exemplary embodiment of the present invention.

When the power supply cable 250 is plugged into a socket, the power supply cable 250 charges the cable type battery 100, and the power supply cable 250 may supply power to an electronic product connected to a power supply terminal 260 thereof. Although not described in FIG. 8, the power supply cable 250 includes a charge unit (not shown) that generates a charge voltage for the cable type battery 100 based on power supplied from the socket.

When the power supply cable 250 is separated from the socket, the power supply cable 250 may supply power stored at the cable type battery 100 to an electronic product connected to the power supply terminal 260. The power supply cable may further include a power supply terminal such as an Universal Serial Bus (USB) terminal 270.

FIG. 9 is a perspective view illustrating clothing 290 including a string 280 that houses a cable type battery 100 according to an exemplary embodiment of the present invention.

The cable type battery 100 is housed in a portion of the string 280, and in an end portion thereof, a connector 290 that connects an external electronic device is provided. When the external device is connected through the connector 290, power of the cable type battery 100 may be transferred to the external device.

For example, when the connector 290 is connected to a charge terminal 310 of a Head Mounted Display (HMD) 300, power of the cable type battery 100 may be transferred to the HMD 300. An HMD auxiliary charge means using the cable type battery 100 may be implemented with a string connected to the HMD. That is, a glasses string of an HMD of a glasses form may include an auxiliary charge cable type battery.

When the connector 290 is connected to a charge terminal 320 of a smart phone 310, power of the cable type battery 100 may be transferred to the smart phone 310. As described above, the string 280 constituting clothing may be used as an excellent power supply means.

FIG. 10 is a perspective view illustrating an example of using a cable type battery 100 housed in a string 340 in a diary 330 having a display function according to an exemplary embodiment of the present invention.

The string 340 performs a function of fixing the diary 330 and houses the cable type battery 100 therein. The cable type battery 100 may supply power to the diary 330 with a wire or wireless method. Power supplied from the cable type battery 100 may be used for charging a battery (not shown) housed in the diary 330 and for directly driving the diary 330.

The diary 330 may perform an image output function and an information providing function through a display 350. For example, as shown in FIG. 10, in the display 350, a residual quantity 351 of a battery housed in the diary 330 may be displayed, and an icon 352 representing that the built-in battery is charging by the cable type battery 100 may be displayed. In the display 350, a residual quantity of the cable type battery 100 may be displayed.

The display 350 may be used as an interfacing means for performing a specific function in which the diary 330 provides. For example, when a touch screen function is mounted in the display 350, the user can control the diary 330 to perform a function with a touch of a button or an icon displayed in the display 350.

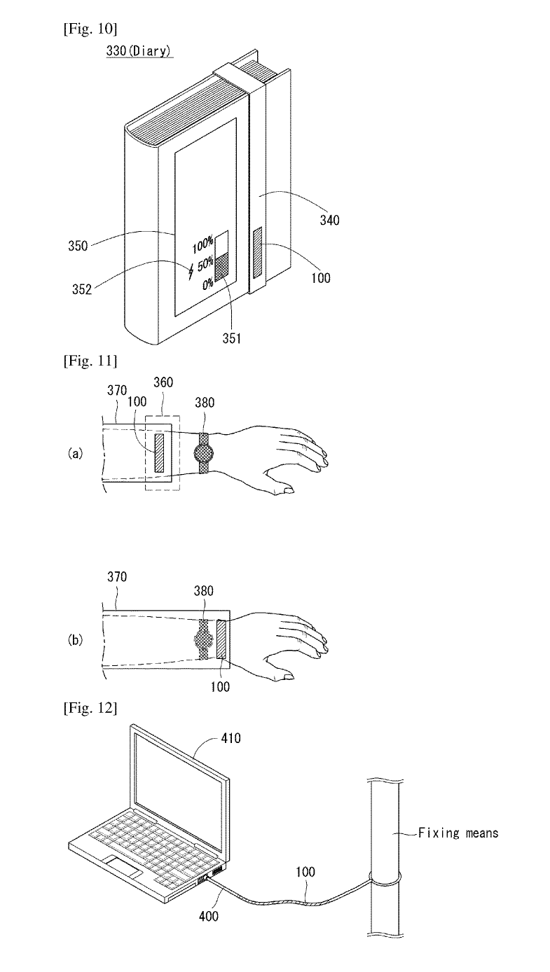

FIG. 11 is a diagram illustrating an example of charging a smart watch 380 using a cable type battery 100 included in an end portion 360 of a sleeve of clothing 370 according to an exemplary embodiment of the present invention.

The cable type battery 100 may supply power for charging a built-in battery of the smart watch 380. Power supply from the cable type battery 100 may be performed according to a predetermined wireless charge method and may be performed through a wire cable. In this case, although not described in the drawing, the clothing 370 should include an element for performing wire or wireless charge.

In a wireless charge method, charge of a built-in battery of the smart watch 380 by the cable type battery 100 may be performed only when the sleeve end portion 360 covers the smart watch 380. For example, as shown in FIG. 11A, when the end portion 360 of the sleeve does not cover the smart watch 380, charge of the built-in battery of the smart watch 380 by the cable type battery 100 is not performed, and as shown in FIG. 11B, when the end portion 360 of the sleeve covers the smart watch 380, charge of the built-in battery of the smart watch 380 by the cable type battery 100 may be performed. Alternatively, when the smart watch 380 is located within an effective charge distance of the predetermined wireless charge method from the end portion 360 of the sleeve, charge of the built-in battery of the smart watch 380 using the cable type battery 100 may be performed.

FIG. 11 illustrates an example of clothing that can charge another electronic device using the cable type battery 100, but the cable type battery 100 may be used as a power supply source of special clothing for performing a specific function such as an exothermic function or pressure generation for a correction function.

FIG. 12 is a diagram illustrating an example of using a cable type battery 100 as a power supply source of a security string 400 that can perform a specific function according to an exemplary embodiment of the present invention.

The security string 400 may be used for fixing an electronic product for exhibition such as a notebook computer 410, as shown in FIG. 12. Although not described in the drawing, the security string 400 may include a module for performing a location track function using power of the cable type battery 100, a module for performing an anti-theft function, and a module for performing an alarm function.

When an attempt that steals the notebook computer 410 fixed to the security string 400 occurs, the security string 400 may generate a warning sound or warning light by primarily activating an anti-theft function, and when the notebook computer 410 is stolen, a function of tracking a location of the notebook computer 410 may be performed.

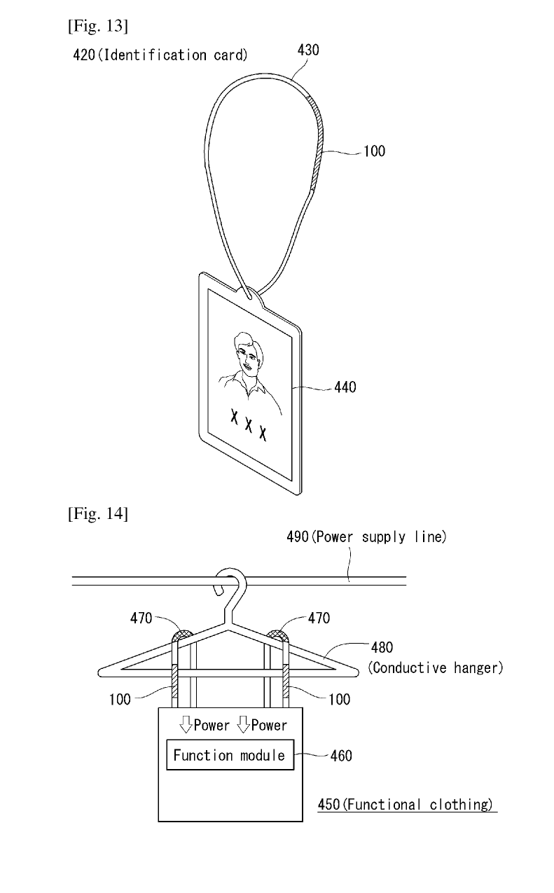

FIG. 13 is a diagram illustrating an example of an identification card 420 including a cable type battery 100 according to an exemplary embodiment of the present invention. Here, an identification card may be an employee card or a specific location pass.

The identification card 420 may include a display 440 that displays a holder's picture or personal information. Here, power for driving the display 440 may be supplied from the cable type battery 100. The cable type battery 100 may be charged by an external charge means. Although not shown in the drawing, the identification card 420 may further include a solar heat-based charge module for charging the cable type battery 100.

The identification card 420 may further include a GPS module that can track a location when stolen or an audio output module. Driving power of such a module may be also supplied from the cable type battery 100.

FIG. 14 is a diagram illustrating functional clothing 450 including a cable type battery 100 that can be charged by external supply power according to an exemplary embodiment of the present invention.

The clothing 450 may include a function module 460 for performing a predetermined function. The function module 460 may be a user body information acquisition module, an exothermic module, a location information acquisition module, a user wearing detection module, and a washing detection module, but a range of the present invention is not limited thereto. Driving power of the function module 460 may be supplied from the cable type battery 100.

The cable type battery 100 may be charged by power supplied through a conductive hanger 480 electrically connected to a power supply line 490. An electrical connection between the hanger 480 and the cable type battery 100 may be performed by a conductive contact terminal 470.

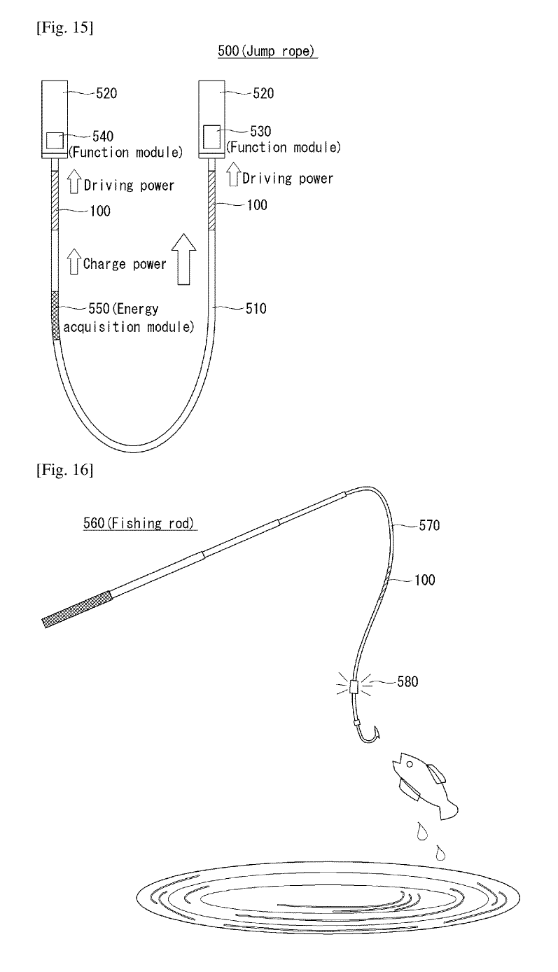

FIG. 15 is a diagram illustrating a jump rope 500 that houses a cable type battery 100 to perform a predetermined function according to an exemplary embodiment of the present invention.

The jump rope 500 may include function modules 530 and 540 for performing a jump rope number counting function, an alarm function, and a consumption calorie measuring function. Driving power of the function modules 530 and 540 may be supplied from the cable type battery 100.

The jump rope 500 may include an energy acquisition module 550 for converting exercise energy occurring by a jump rope operation to a charge voltage of the cable type battery 100. That is, a user can charge the cable type battery 100 while performing a jump rope exercise. Power of the cable type battery 100 may be transferred to other electronic devices. Although not described in the drawing, the jump rope 500 may further include a connection means for connection to another electronic device in order to transfer power to the another electronic device.

FIG. 16 is a diagram illustrating a fishing rod 560 including a cable type battery 100 according to an exemplary embodiment of the present invention.

A fishing line 570 of the fishing rod 560 includes the cable type battery 100 and includes a light emitting element 580 that generates light with power supplied from the cable type battery 100. Light generated by the light emitting element 580 may perform a function of collecting fish while performing night fishing and perform a function of attracting an attention of an adjacent fisherman.

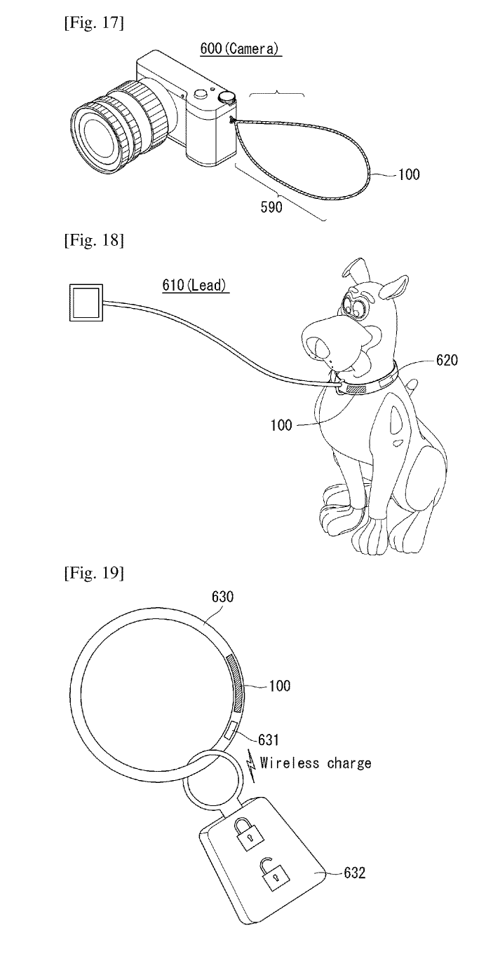

FIG. 17 is a diagram illustrating an example of using a cable type battery 100 housed in a string 590 as an auxiliary battery of a camera 600 according to an exemplary embodiment of the present invention.

The camera 600 is driven with a built-in battery. However, when photographing is performed at the outside for a long time, a capacity of the built-in battery becomes another restriction. When the built-in battery is completely discharged or is discharged to a predetermined level or less, the camera 600 may receive driving power from the cable type battery 100. The camera 600 may receive driving power from the cable type battery 100 by a user manipulation. The cable type battery 100 may supply power for charging a built-in battery of the camera 600 when a predetermined condition is satisfied or by a user manipulation.

FIG. 18 is a diagram illustrating an example of a pet lead 610 including a cable type battery 100 according to an exemplary embodiment of the present invention.

The lead 610 includes the cable type battery 100 and a location track module 620. The location track module 620 receives power from the cable type battery 100 when a predetermined condition is satisfied to transmit location information. Therefore, a pet owner may receive the transmitted location information to determine a location of a pet in which the lead 610 is worn. Unlike a case of FIG. 18, the cable type battery 100 may be housed in a string that connects a portion wound in a neck and a handle instead of a portion wound in a neck of a pet.

The cable type battery 100 may perform a power supply function for performing another function provided by the lead 610 instead of a location track function. For example, the cable type battery 100 may perform a function of a power supply source of a module (not shown) for performing a function of loosening or tightening a portion wound in a neck of a pet.

FIG. 19 is a diagram illustrating a key ring 630 that houses a cable type battery 100 according to an exemplary embodiment of the present invention.

The key ring 630 includes the cable type battery 100 and a wireless charging unit 631 that can transmit a wireless charge signal with power of the cable type battery 100. A battery housed in an electronic key 632 mounted in the key ring 630 may be charged by a wireless charge signal transmitted from the wireless charging unit 631. Unlike a case of FIG. 19, power of the cable type battery 100 may be supplied by a wire to a built-in battery charge voltage of the electronic key 632 mounted in the key ring 630.

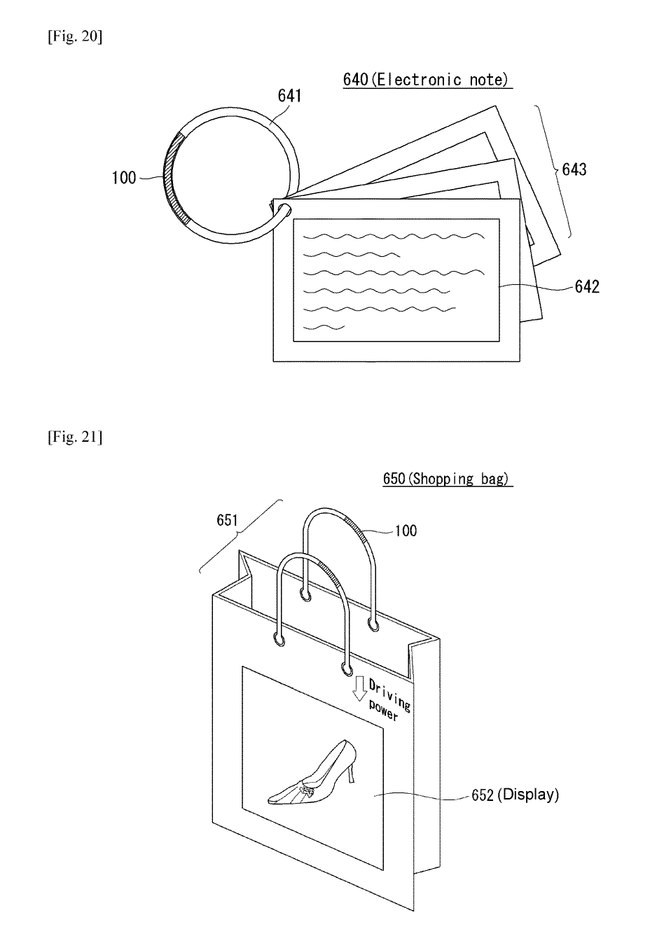

FIG. 20 is a diagram illustrating an example of an electronic note 640 including a ring fixing means 641 that houses a cable type battery 100 according to an exemplary embodiment of the present invention.

The electronic note 640 may be formed with a plurality of pages 643 each including a display area 642. Driving power of a display area of each of the plurality of pages 643 may be supplied from the cable type battery 100 housed in the ring fixing means 641.

The electronic note 640 may further include a means for detecting that a page thereof passes through the ring fixing means 641. In order to drive a display area of a page in which passing of the ring fixing means 641 is detected, a controller (not shown) of the electronic note 640 enables power of the cable type battery 100 to be supplied.

FIG. 21 is a diagram illustrating an example of a shopping bag 650 including a handle 651 including a cable type battery 100 according to an exemplary embodiment of the present invention.

The shopping bag 650 includes a display 652 that receives power from the cable type battery 100 housed in the handle 651 to output image data. Although not described in the drawing, the shopping bag 650 may further include an audio output means that can output an audio signal corresponding to the image data. Driving power of the audio output means may be also supplied from the cable type battery 100.

Image data or an audio signal output through an output means provided in the shopping bag 650 may be image data or an audio signal of a product seller corresponding to the shopping bag 650 or a corresponding product. That is, the shopping bag 650 may be a promotion or sale means of a corresponding product seller or a corresponding product.

When a controller (not shown) of the shopping bag 650 detects that a product is put in the shopping bag, if a grip of the handle 651 of the shopping bag 650 is detected for a predetermined time or more, the controller may control the display 652 to output image data. In this case, the shopping bag 650 should include a separate detect means for detecting the above-described conditions.

When manipulation of a separately provided driving switching means (not shown) is detected, the controller may control the display 652 to output image data.

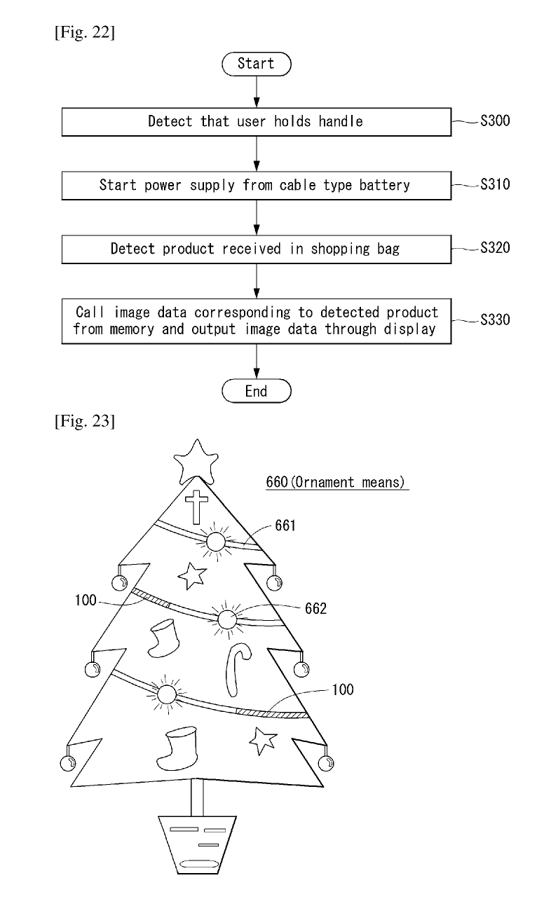

FIG. 22 is a flowchart illustrating another example of a method of using a cable type battery according to an exemplary embodiment of the present invention. Hereinafter, a method of using the cable type battery will be described with reference to necessary drawings. For reference, a method of using the cable type battery is a method of using an exemplary embodiment described with reference to FIG. 21.

When it is detected that a user holds the handle 651 of the shopping bag 650 (S300), a trigger signal for starting an image data output operation stored at a memory (not shown) of the shopping bag 650 occurs, and the controller (not shown) of the shopping bag 650 starts power supply from the cable type battery 100 in response to the trigger signal (S310).

The cable type battery may be housed in a packing material such as paper or vinyl forming a body of the shopping bag 650 instead of the handle 651. The trigger signal may occur when a specific product is received into the shopping bag 650 instead of handle holding of a user.

When power supply from the cable type battery 100 is started, the controller drives a driving application (i.e., application program) stored at the memory and detects a product received in the shopping bag 650 (S320). It may be detected whether the product is received by a short range wireless communication module housed in the shopping bag 650 and a communication means provided within the product or wireless communication with a tag of the product.

When reception of the product is detected, the controller calls image data corresponding to the detected product from the memory and outputs the image data through the display 652 (S330). The output image data may be different according to a kind of the detected product.

FIG. 23 is a diagram illustrating an example of an ornament means 660 of a cable form including a cable type battery 100 according to an exemplary embodiment of the present invention.

The ornament means 660 is implemented by a cable 661 that houses the cable type battery 100, and a plurality of light emitting elements 662 are connected to the cable 661. Driving power of the plurality of light emitting element 662 may be supplied from the cable type battery 100. Therefore, the ornament means 660 may be driven even at a location at which a separate power supply means is not provided.

The cable type battery 100 may be charged by external supply power. Although not described in the drawing, the ornament means 660 may further include an audio output means that receives power from the cable type battery 100 for driving.

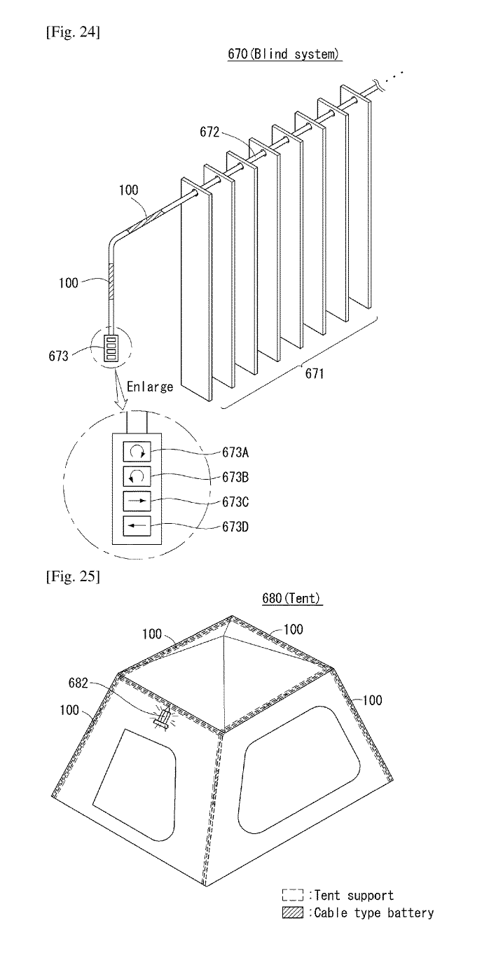

FIG. 24 is a diagram illustrating an example of a blind system 670 driving with a cable type battery 100 according to an exemplary embodiment of the present invention.

The blind system 670 may perform rotation and moving operations of blind slats 671 with power of the cable type battery 100. Therefore, the blind system 670 may be independently driven even in a state in which a separate power supply means is not provided. In this case, although not described in the drawing, the blind system 670 should include a controller and a driving module.

The cable type battery 100 may be charged by external supply power. In this case, the blind system 670 should include a charge module for charging the cable type battery 100 with external supply power. Although not described in the drawing, one surface of at least one of the blind slats 671 may include a solar heat charge module for charging the cable type battery 100. At least one surface of the blind slats 671 may include a display area.

The blind system 670 may control a rotation and movement of the blind slats 671 according to a previously reserved operation pattern. In this case, the reserved operation pattern may be stored at a memory (not shown). A rotation and movement of the blind slats 671 may be performed by a manipulation of a remote control 673 of a user. As shown in FIG. 24, the remote control 673 may include buttons 673A and 673B for rotating the blind slats 671 and buttons 673C and 673D for laterally moving the blind slats 671.

FIG. 25 is a diagram illustrating an example of a tent 680 including a cable type battery 100 that can be used as a power supply source of a related electronic device according to an exemplary embodiment of the present invention.

The tent 680 may include a tent support that houses the cable type battery 100 therein. Power of the cable type battery 100 may be used as power of a lantern 681, as shown in FIG. 25. Although not described in the drawing, at the inside of the tent support, a conductive path for supplying power of the cable type battery 100 may be formed.

Although not described in the drawing, the cable type battery 100 may be used as a driving power source of various camping supplies in addition to the lantern 681. The cable type battery 100 having flexibility may be included in a portion of cloth constituting a tent as well as a tent support.

FIG. 26 is a diagram illustrating a tennis racket 690 including a racket line 691 including a cable type battery 100 according to an exemplary embodiment of the present invention.

A racket line 691 is disposed in a net form within a head of the tennis racket 690, and in a portion of the racket line 691, the cable type battery 100 is housed. The cable type battery 100 may be used as a power supply source for performing a specific function mounted in the tennis racket 690.

The specific function mounted in the tennis racket 690 may include an exercise time measuring function, a function of measuring a hitting point of a tennis ball, a function of adjusting a tension of the racket line 691, a function of detecting a moving direction of a tennis ball, and a light emitting function. However, a range of the present invention is not limited thereto.

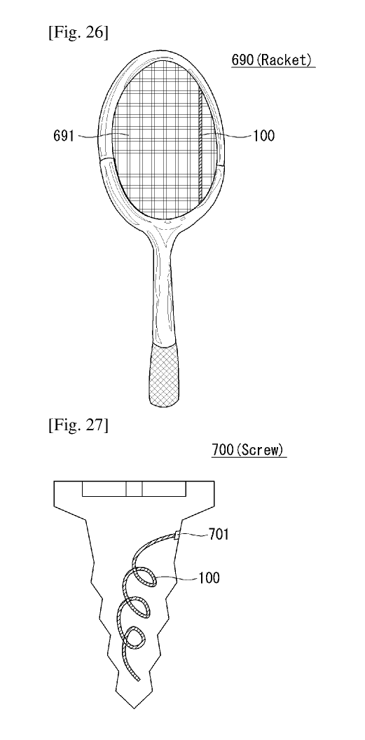

FIG. 27 is a cross-sectional view illustrating a screw 700 including a cable type battery 100 according to an exemplary embodiment of the present invention.

The cable type battery 100 is housed within the screw 700. Power of the cable type battery 100 may be supplied to a device to which the screw 700 is coupled through a discharge terminal 701. The discharge terminal 701 may be also used as a charge terminal. According to another implementation, in a screw, a discharge terminal and a charge terminal may be separately provided.

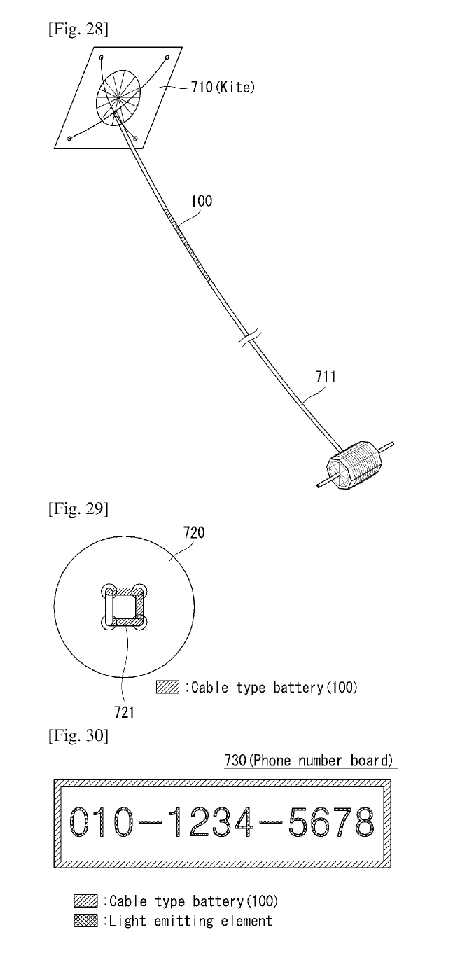

FIG. 28 is a diagram illustrating an example of using a string 711 of a material that houses a cable type battery 100 therein as a kite line according to an exemplary embodiment of the present invention.

The cable type battery 100 housed in the string 711 may supply power for outputting an audio signal through an audio output means (not shown) mounted in a kite 710, for outputting an image signal through a display (not shown) mounted in the kite 710, or for a light emitting operation of a light emitting element (not shown) mounted in the kite 710. Further, the cable type battery 100 may supply power for operation of a location information acquisition module (not shown) mounted in the kite 710.

The string 711 that houses the cable type battery 100 may be used for supplying power for a flight of a model plane and a pilotless plane connected to the string 711 or power for performing a specific function as well as the above-described kite 710.

FIG. 29 is a diagram illustrating a button 720 fixed by a thread 721 that houses a cable type battery 100 according to an exemplary embodiment of the present invention.

The cable type battery 100 housed in the thread 721 may be used as a power supply source for performing a specific function that can be performed by the button 720. For example, when a user manipulation of the button 720 is detected, the button 720 may perform a wire/wireless switching operation of an external device or clothing to which the button 720 is fixed using power of the cable type battery 100. Further, the cable type battery 100 may be used as a driving power supply source of the clothing or the external device.

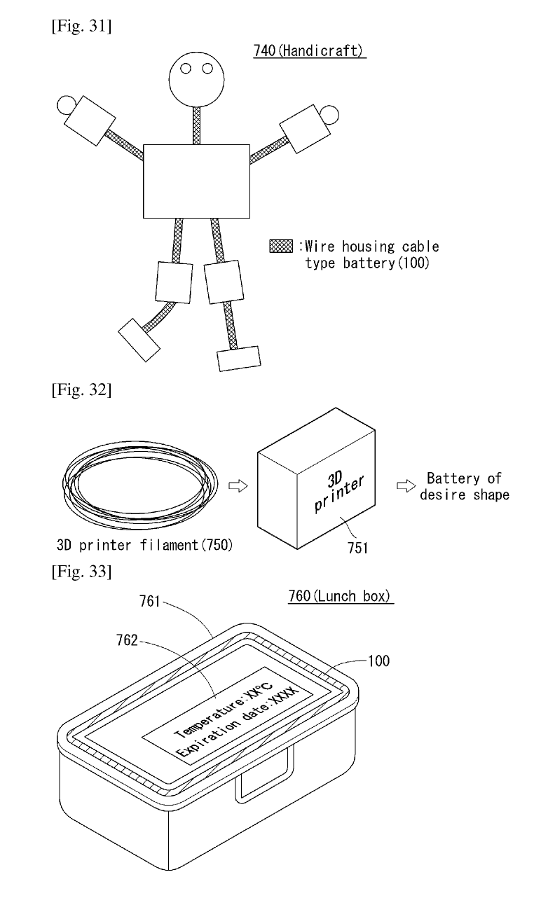

FIG. 30 is a diagram illustrating an example of a phone number board 730 that houses a cable type battery 100 according to an exemplary embodiment of the present invention.

The phone number board 730 may be used for a light emitting operation of a phone number formed with a light emitting element using power of the cable type battery 100. A light emitting color of the light emitting element may be changed according to a predetermined pattern. When such a phone number board 730 is made with a cross stitch method, the cable type battery 100 may be housed within a cross stitch thread.

The cable type battery 100 may be used for driving a lighting means housed in a license plate to illuminate a license plate number displayed in the license plate and may be used for emitting a license plate number formed with a self light emitting element.

FIG. 31 illustrates an example of a handicraft 740 made using a wire that houses a cable type battery 100 according to an exemplary embodiment of the present invention.

Each constituent element of the handicraft 740 is connected using the wire. The cable type battery 100 may be housed within the wire. Power of the cable type battery 100 may be used when the handicraft performs a physical operation. Power of the cable type battery 100 may be used as an energy source of an audio output operation, an image output operation, a light emitting operation, and a vibration generation operation of the handicraft 740. That is, because the cable type battery 100 is housed within a wire constituting the handicraft 740, the handicraft 740 does not require a separate battery.

FIG. 32 is a diagram illustrating an example of using a material of a cable type battery 100 as a filament material of a 3D printer 751 according to an exemplary embodiment of the present invention.

Referring to FIG. 32, when forming the 3D printer 751 using a material of the cable type battery 100 as a filament material, a desire shape of battery can be formed.

FIG. 33 is a diagram illustrating an example of a lunch box 760 that houses a cable type battery 100 according to an exemplary embodiment of the present invention.

Power of the cable type battery 100 may be used for performing a specific function mounted in the lunch box 760. For example, power of the cable type battery 100 may be used for driving a display 762 provided in a cover of the lunch box 760. In the display 762, a temperature and the expiration date of a lunch box may be displayed. Power of the cable type battery 100 may be used for performing a temperature adjustment function of keeping warm, heating, refrigeration, and freezing of the lunch box 760.

FIG. 34 is a diagram illustrating an example of a tape 770 that houses a cable type battery 100 according to an exemplary embodiment of the present invention.

It is preferable that the cable type battery 100 is housed in the tape 770 in a thin film form in order to minimize deterioration of an intrinsic bonding or fixing function of the tape 770. The cable type battery 100 may be used as a power supply source of a product to which the tape 770 is bonded. The cable type battery 100 may be charged by external power before or after being bonded to other products.

FIG. 35 is a diagram illustrating an example of a clothing string 780 that houses a cable type battery 100 according to an exemplary embodiment of the present invention.

Power of the cable type battery 100 may be used for performing a specific function of clothing in which the clothing string 780 is mounted. For example, power of the cable type battery 100 may be used for changing a color of mounted clothing, performing a keeping warm function of mounted clothing, or performing a correction function of mounted clothing. However, a range of the present invention is not limited thereto.

FIG. 36 is a diagram illustrating an example of a tag 790 that houses a cable type battery 100 according to an exemplary embodiment of the present invention.

The cable type battery 100 is housed in a fixing string 791 of the traveling bag tag 790. Power of the cable type battery 100 may be used as driving power of a display 792 of the tag 790. In a display area, an owner name, a travel date, etc., may be displayed. However, a range of the present invention is not limited thereto.

A form of such a tag may be a traveling bag tag shown in FIG. 36, may be a bookmark, and may be a tag of a specific product. When the tag is a bookmark, in the display, a page and a title of a book may be displayed. When the tag is a tag of a specific product, in the display, a product description may be displayed.

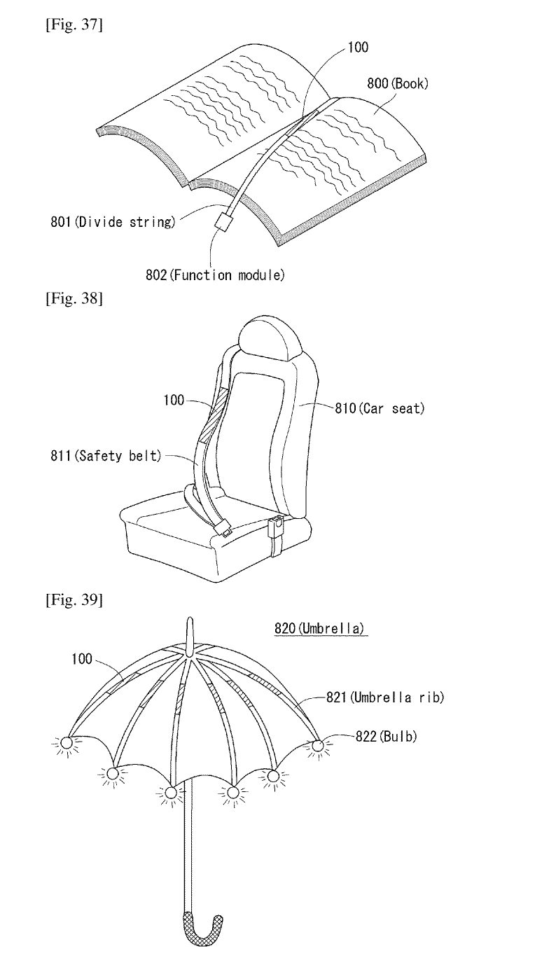

FIG. 37 is a diagram illustrating an example of a divide string 801 of a book that houses a cable type battery 100 according to an exemplary embodiment of the present invention.

The cable type battery 100 may be used as a power supply source of a function module 802 for performing a specific function mounted in the divide string 801. The function module 802 may be a module for performing a singular number light emitting function, a book page display function, and an audio signal output function. However, a range of the present invention is not limited thereto.

FIG. 38 is a diagram illustrating an example of a safety belt 811 that houses a cable type battery 100 according to an exemplary embodiment of the present invention.

When a user sits a car seat 810, power of the cable type battery 100 may be used for tightly fastening or loosely releasing the safety belt 811.

FIG. 39 is a diagram illustrating an example of an umbrella 820 that houses a cable type battery 100 according to an exemplary embodiment of the present invention.

As shown in FIG. 39, the cable type battery 100 may be housed within an umbrella rib 821 of the umbrella 820. Alternatively, the cable type battery may be housed within cloth forming an umbrella. Power of the cable type battery 100 may be used for emitting a light emitting element provided in the umbrella 820, as shown in FIG. 39.

Power of the cable type battery 100 may be used for performing other functions mounted in the umbrella 820. The other functions may include an exothermic function for drying the umbrella 820 and a spreading and folding function of the umbrella 820. However, a range of the present invention is not limited thereto.

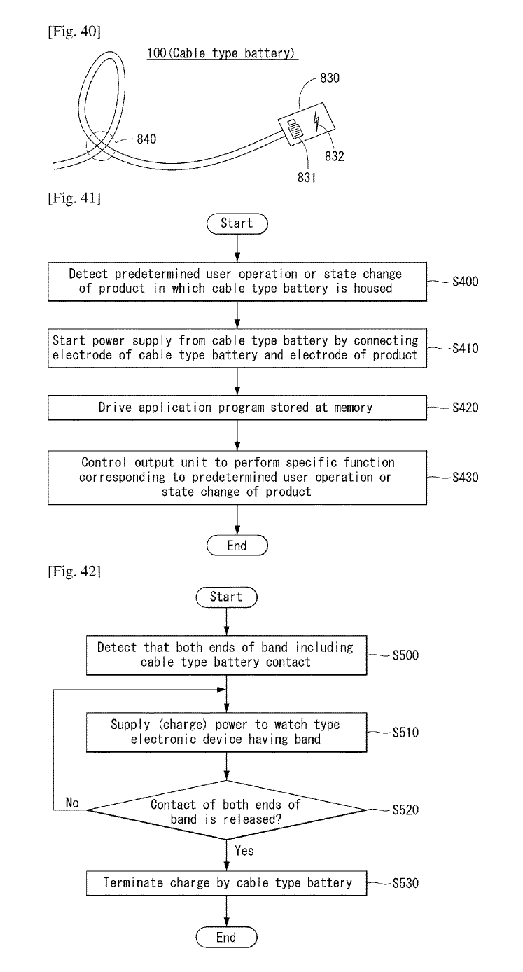

FIG. 40 is a diagram illustrating a method of using a cable type battery 100 according to an exemplary embodiment of the present invention.

In a display 830 of the cable type battery 100, operation state information of the cable type battery 100 may be displayed. The operation state information may include a battery residual quantity and charge notification, as shown in FIG. 35. However, a range of the present invention is not limited thereto. For example, the operation state information may further include related information of an electronic device to which the cable type battery 100 is connected and discharge notification. Although not described in the drawing, the cable type battery 100 should include an information acquisition module for acquiring the above-described operation state information.

The information acquisition module may detect a twisted and overlapped portion of a portion of a cable, as shown in FIG. 40. In this case, a controller (not shown) of the cable type battery 100 may change a color of the overlapped portion or may display a twisted form in the display 830. The information acquisition module may acquire information on whether the cable type battery 100 is grounded or is in a chargeable state.

FIG. 41 is a flowchart illustrating another example of a method of using a cable type battery according to an exemplary embodiment of the present invention. Hereinafter, a method of using the cable type battery will be described with reference to necessary drawings.

A controller 80 of a product 10 that houses the cable type battery 100 according to an exemplary embodiment of the present invention detects a predetermined user operation of the product 10 or a predetermined state change of the product (S400). Such a user operation or a state change of the product 10 may be detected by at least one sensing means provided in the product 10 and may be detected as the controller 80 directly detects an electromagnetic signal occurring by the user operation or a state change of the product 10.

When the product 10 is a shopping bag, the predetermined user operation of the product 10 may be operation in which the user holds a handle of the shopping bag, and the state change of the product 10 may be a state change in which the product is received in an empty shopping bag. When the cable type battery 100 is implemented in a string form, a predetermined user operation of the product 10 may include operation of winding the cable type battery 100 in the product 10, operation of unwinding the cable type battery 100 wound in the product 10, operation of tying a knot with the cable type battery 100, and operation of untying a knot of the cable type battery 100. The above-described examples are an example of a user operation of the product 10 or a state change of the product 10 for starting a method of using a cable type battery according to an exemplary embodiment of the present invention and a range of the present invention is not limited thereto.

When a predetermined user operation of the product 10 or a state change of the product 10 is detected, the controller 80 starts power supply from the cable type battery 100 by connecting an electrode of the cable type battery 100 and an electrode of the product 10 based on the detect result (S410). A connection between the electrodes may be a mechanical connection of a physical switch by a physical force occurring by a predetermined user operation or state change and may be performed by a switching operation of a micro switching element in which a transistor includes a diode based on a control signal occurring by the predetermined user operation or state change.

When power is supplied from the cable type battery 100, the controller 80 drives an application program stored at the memory 60 based on power supplied from the cable type battery 100 (S420) and controls the output unit 50 to perform a specific function corresponding to the predetermined user operation or the predetermined state change of the product (S430).

The specific function may be a function of outputting image data stored at the memory 60 through the display unit 51, a function of outputting audio data stored at the memory 60 through the audio output unit 52, and a function of performing both. The specific function may include a light emitting operation using a light emitting element included in the output unit 50 and vibration generation using a vibration generation element included in the output unit 50. However, a range of a specific function performed by the product 10 is not limited to the above-described examples.

FIG. 42 is a flowchart illustrating another example of a method of using a cable type battery according to an exemplary embodiment of the present invention. Hereinafter, a method of using the cable type battery will be described with reference to necessary drawings.

The controller 80 of the product 10 that houses the cable type battery 100 according to an exemplary embodiment of the present invention may detect a predetermined user operation of the product 10 or a predetermined state change of the product and control the product 10 to execute a predetermined function based on the predetermined user operation or the predetermined state change.

Here, the product 10 may be a watch type electronic device having a wearable band.

Referring to FIG. 42, the controller 80 may detect that both ends of the band including a cable type battery contact (S500). Here, a case in which both ends of the band contact will be described in detail later with reference to FIG. 43.

The controller 80 may supply power to a watch type electronic device having the band (S510). The power supply unit 90 of the product 10 may be charged by the cable type battery 100.

The controller 80 may determine whether a contact of the both ends of the band is released (S520), and if a contact of the both ends of the band is released, the controller 80 may terminate charge by a cable type battery (S530).

As a main device 900 has a separate power supply unit (battery), a watch function may be executed with power provided by the power supply unit source, but a watch type electronic device according to an exemplary embodiment of the present invention can perform various functions in addition to the watch function. Accordingly, a problem that should solve consumption power remains, and according to an exemplary embodiment of the present invention, as a band of a watch type electronic device houses a cable type battery therein, the watch type electronic device can execute various functions in addition to a pure watch function by the cable type battery. Hereinafter, various use examples of a cable type battery will be described with reference to necessary drawings.

Referring to FIG. 43A, the watch type electronic device may include a main device 900 and bands 901 and 902 connected to the main device 900 to be worn in a wrist or an arm.

The watch type electronic device is formed to perform wireless communication, and in the main device 900, an antenna for the wireless communication may be installed. A display unit 951 is disposed at a front surface of the main device 900 to output information, and a touch sensor is provided in the display unit 951 and thus the display unit 951 may be implemented with a touch screen.

The main device 900 may have various electronic components in addition to constituent elements of the foregoing display unit 951.

Referring to FIG. 43B, the bands 901 and 902 are worn in a wrist to enclose the wrist and may be made of a flexible material for easy wearing. As such an example, the bands 901 and 902 may be made of leather, rubber, silicon, synthetic resin, etc. Further, as the bands 901 and 902 are detachably formed in the main device 900, the bands 901 and 902 may be replaced with bands of various forms according a user taste.

The bands 901 and 902 may have a fastener (not shown). The fastener may be implemented by a buckle, a hook structure that can perform a snapfit connection, or Velcro (brand name) and may include a flexible segment or material.

Further, referring to FIG. 43A, the bands 901 and 902 may have the cable type battery 100. The cable type battery 100 is housed within the bands 901 and 902 to contact with one end of the main device 900. The cable type battery 100 is connected to the main device 900 by an electrode contact to provide charge power to the main device 900.

Further, referring to FIGS. 43A and 43B, the bands 901 and 902 may be formed with a first band 901 connected to a first terminal of the main device 900 and a second band 902 connected to a second terminal of the main device 900. The first band 901 and the second band 902 are connected to each other to perform an electrode contact. In this case, power of the cable type battery 100 may be supplied to the main device 900.

In some case, the first band 901 and the second band 902 may be integrally formed to form one band. In this case, as the band is worn in a wrist with elasticity, when an entire diameter of the band increases, power may be supplied to the main device 900. Here, the diameter is a length to another point located at an angle of 180° from one point of the band.

Referring to FIG. 43B, in a state in which the display unit 951 of the main device 900 is turned off, when one end 910 of the first band 901 and one end 920 of the second band 902 contact, the display unit 951 may be turned on through power supplied by the cable type battery 100.

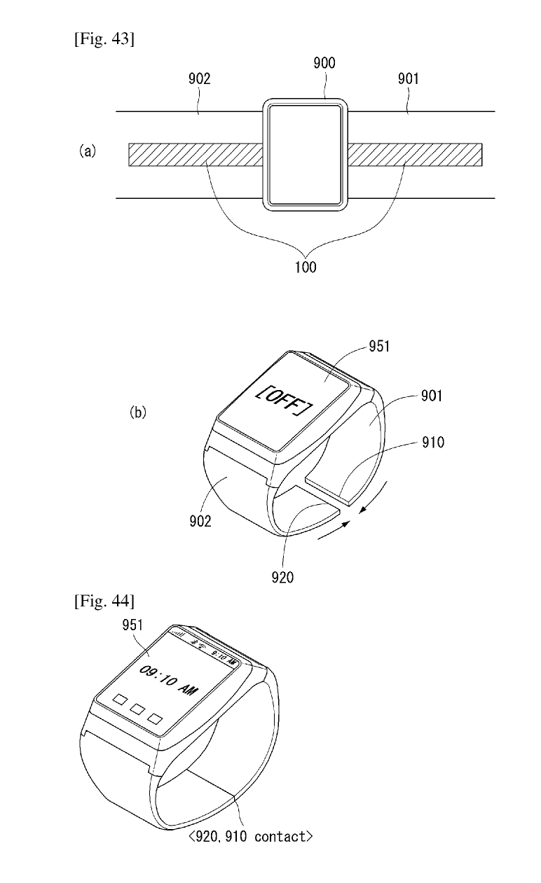

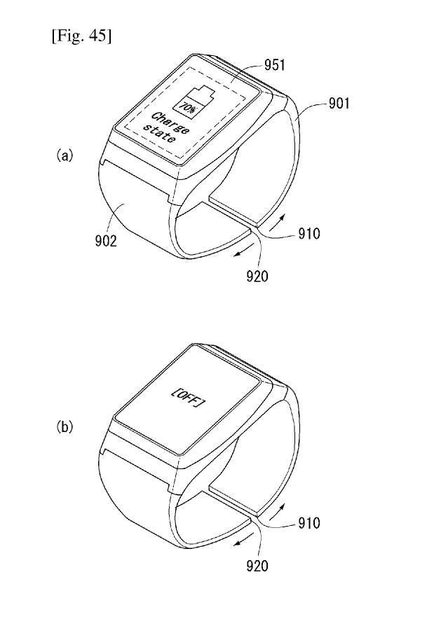

Referring to FIG. 44, when a contact of the first band 901 and the second band 902 is released, the controller 80 may provide a charge state by the cable type battery 100 to the display unit 951 and turn off again the display unit 951.

As described above, a watch type electronic device may perform a pure watch function, but together execute various functions with the external device through data communication. According to an exemplary embodiment of the present invention, a function of the watch type electronic device may be divided into a first function that performs a watch function and a second function that can operate as a smart device separate from a watch function according to a location of a source of supplied power. For example, when the watch type electronic device performs only a watch function (first function), the watch type electronic device requires only a separate battery (e.g., mercury cell) necessary for performing a watch function. However, in order to perform the second function, by activating a cable type battery housed within the band, a consumption power problem of the watch type electronic device can be solved.

According to an exemplary embodiment of the present invention, a band of the watch type electronic device may be made of a material having predetermined elasticity and may control operation of the watch type electronic device through a change of various external forms applied to the band. Hereinafter, an example that can use the cable type battery in order to execute a function of the watch type electronic device through a change of various external forms applied to the band will be described.

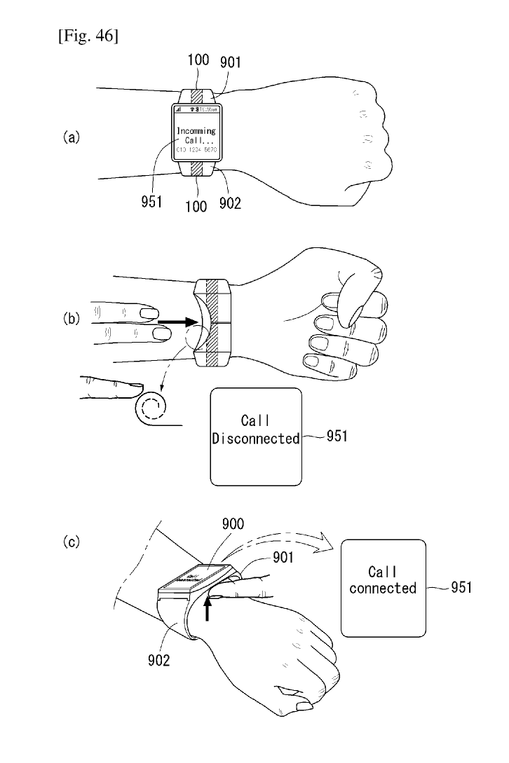

FIGS. 46 to 48 are diagrams illustrating an example of controlling operation of a watch type electronic device with a change of an external form of a cable type battery.

Referring to FIG. 46A, the controller 80 of a watch type electronic device may have a mobile communication module and receive an incoming call through the mobile communication module. Power for driving the mobile communication module may be provided by the cable type battery 100. Further, an entire function linked to the mobile communication module to be executed may be executed through power provided by the cable type battery 100.

The bands 901 and 902 connected to the watch type electronic device may be made of a material that can be easily changed and have predetermined elasticity.

Accordingly, referring to FIG. 46B, as an external force is applied to a point of a band worn in a wrist, at least a portion of the band may be wound. When the controller 80 detects that at least a portion of the band is wound, the controller 80 may terminate the received incoming call.

That is, an external force applied to the band is transferred to the cable type battery 100, and as an external form of the cable type battery 100 is changed, the controller 80 may detect the change. The controller 80 may control execution of a predetermined event received from the outside according to a user gesture of the cable type battery 100.

Referring to FIG. 46C, as a gesture that lifts the main device 900 upward is input while receiving the incoming call, an external form of the first band 901 and the second band 902 connected to the main device 900 may be changed. The controller 80 may connect the incoming call in response to an external form change of the band.

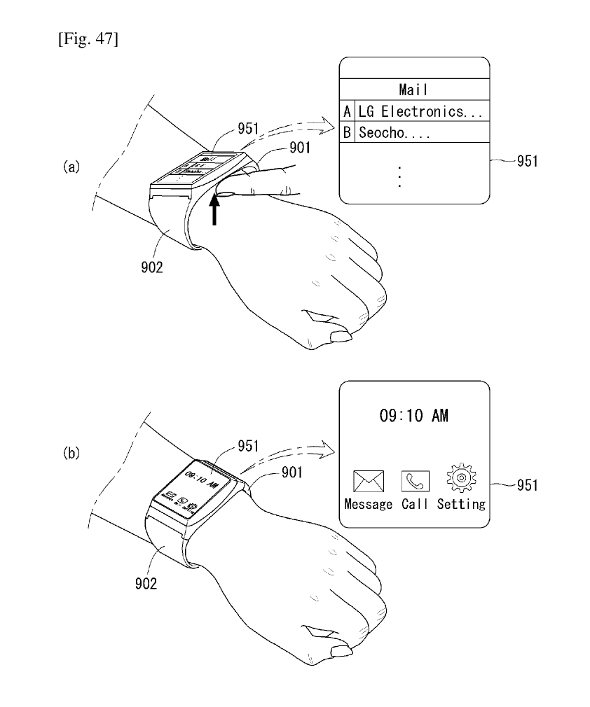

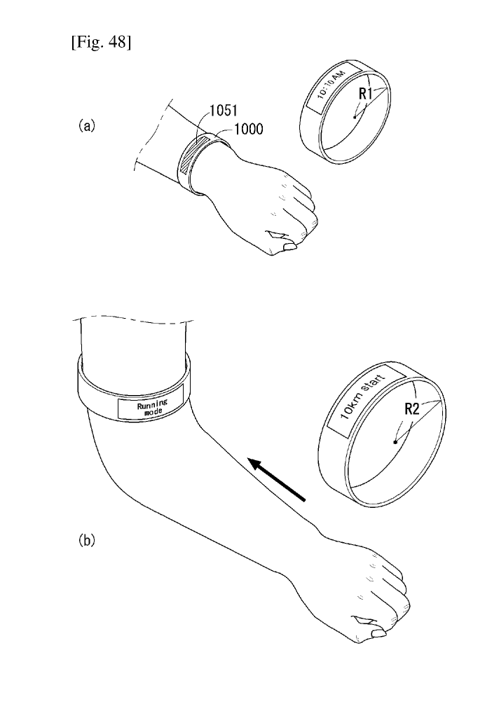

Referring to FIG. 47, the controller 80 may execute a specific application (e.g., E-Mail) in a watch type electronic device and provide a result thereof to the display unit 951. In a state in which an execution screen of the application is provided to the display unit 951, when an external form of the bands 901 and 902 is changed, as described in FIG. 46C, the controller 80 may terminate the application and provide a home screen to the display unit 951.

In the foregoing example, it has been described that an external form of the band is changed, but as an external form of the band is changed, an external form of the cable type battery 100 may be together changed. Accordingly, according to an exemplary embodiment of the present invention, while the cable type battery 100 supplies power to a watch type electronic device, a predetermined function is executed, and as an external form of the cable type battery 100 is changed, execution of the predetermined function may be together controlled.

Referring to FIG. 48, a product 1000 according to an exemplary embodiment of the present invention may include a watch type electronic device having a wearable band.

The band may have flexibility, and as the band is worn in a user wrist or arm, a diameter of the band may increase.

According to an exemplary embodiment of the present invention, when a diameter of a band that houses a cable type battery 100 is a first diameter R1 and a second diameter R2, power supply by the cable type battery 100 may be selectively controlled.

For example, when the band is worn in a user wrist and a diameter of a band is a first diameter R1, a screen according to a watch function may be output through a display unit 151 (see FIG. 48A). In this case, power for executing the watch function may be power by a power supply unit 90 (built-in battery) housed in the watch type electronic device instead of power of the cable type battery 100.

When a wearing location of the band moves from a user wrist to a user arm, if a diameter of the band is a second diameter R2, the controller 80 may control the watch type electronic device to operate in an exercise mode. That is, the controller 80 may execute a predetermined application for supporting an exercise of the user and provide a screen according to the exercise mode to the display unit 951. When the watch type electronic device enters an exercise mode, the controller 80 may receive power for execution of the application by the cable type battery 100.

That is, according to an exemplary embodiment of the present invention, when a diameter of a band that houses the cable type battery 100 exceeds a predetermined threshold, the controller 80 may determine that the user wants to use the watch type electronic device for an exercise and activate power supply (or charge) by the cable type battery 100.

A method of using a cable type battery according to an exemplary embodiment of the present invention may be performed by a combination of the above-described respective exemplary embodiments.

The foregoing present invention may be implemented with a computer readable code in a medium on which a program is recorded. A computer readable medium includes an entire kind of record devices that store data that can be read by a computer system. The computer readable medium may include, for example, a Hard Disk Drive (HDD), a Solid State Disk (SSD), a Silicon Disk Drive (SDD), a Read-Only Memory (ROM), a Random-Access Memory (RAM), a Compact Disc Read-Only Memory (CD-ROM), a magnetic tape, a floppy disk, and a light data storage device and may be implemented in a form of a carrier wave (e.g., transmit through Internet). Further, the computer may include a controller of a product that houses a cable type battery. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### Sequence Listing Free Text

10: product
51: display unit
52: audio output unit
60: memory
100: cable type battery

1. A method of using a cable type battery in a product comprising a cable type battery, a memory, and an output unit, the method comprising:
detecting a predetermined user operation for the product or a predetermined state change of the product;
starting power supply from the cable type battery by connecting an electrode of the cable type battery and an electrode of the product based on the detect result; and
controlling the output unit to perform a specific function corresponding to the predetermined user operation or the predetermined state change of the product by driving an application program stored at the memory based on power supplied from the cable type battery.

2. The method of claim 1, wherein the specific function comprises at least one of:
a function of outputting image data stored at the memory through a display unit included in the output unit; and
a function of outputting audio data stored at the memory through an audio output unit included in the output unit.

3. The method of claim 2, wherein the cable type battery is implemented in a string form, and
the predetermined user operation comprises at least one of operation of winding the cable type battery in the product, operation of unwinding the cable type battery wound in the product, operation of tying a knot with the cable type battery, and operation of untying the knot tied with the cable type battery.

4. The method of claim 2, wherein the product is a shopping bag, and
the predetermined user operation comprises operation in which the user holds a handle of the shopping bag.

5. The method of claim 2, wherein the product is a shopping bag, and
the predetermined state change of the product comprises a state change in which a product is received in the empty shopping bag.

6. The method of claim 2, wherein the product is a shopping bag, and the cable type battery is housed in a handle of the shopping bag.

7. The method of claim 2, wherein the product is a shopping bag, and the cable type battery is housed in a packing material forming a body of the shopping bag.

8. The method of claim 2, wherein the product is a shopping bag, and
the predetermined state change of the product comprises a state change in which a product is received in the empty shopping bag,
wherein the method further comprises detecting a product received in the shopping bag, and
the image data or the audio data is changed according to a kind of the detected product.

9. The method of claim 2, wherein the product is a packing box, and
the cable type battery is housed within a packing means of the packing box.

10. The method of claim 2, wherein the product is a packing box sealed by a packing means, and
the cable type battery is housed within a packing material forming a body of the packing box.

11. The method of claim 9, wherein the predetermined user operation comprises operation of releasing packing of the packing box by the packing means.

12. The method of claim 9, further comprising detecting a product received in the packing box,
wherein the image data or the audio data is changed according to a kind of the detected product.

13. The method of claim 1, wherein the product comprises a watch type electronic device having a band comprising the cable type battery, and
the state change of the product comprises a contact of one end and the other end of the band in a state in which power of the electronic device is turned off.

14. The method of claim 13, wherein the specific function is to turn on the electronic device by power supplied by the cable type battery.

15. The method of claim 14, wherein the electronic device is charged by the cable type battery after one end and the other end of the band contact, and the charge is stopped, when the contact is released.

16. The method of claim 15, wherein the display unit is turned off after a charge state by the cable type battery is displayed in a display unit of the electronic device, when the contact is released.

17. The method of claim 1, wherein the product comprises the cable type battery and comprises a watch type electronic device having a band having elasticity, and
the state change of the product comprises a change of elasticity of the band or a change of an external form of the band in a state in which the band is worn in a user arm.

18. The method of claim 17, wherein the specific function is to execute an event received from the outside based on a state change of the product.

19. The method of claim 17, wherein the specific function comprises a function of terminating a previously executing application.

20. The method of claim 17, wherein the specific function is to convert a mode of the watch type electronic device to an exercise mode, when a diameter of the band increases due to a change of elasticity of the band in a state in which the band is worn in an arm of the user.
